(19) United States
(12) Patent Application Publication
(10) Pub. No.: US 2012/0029110 A1
(43) Pub. Date: Feb. 2, 2012

(54) PHOTOPOLYMERIZABLE RESIN COMPOSITION FOR TRANSFERRING MICROSTRUCTURE

(76) Inventors: Ryuta WASHIYA, Hitachi (JP); Masahiko Ogino, Hitachi (JP); Noritake Shizawa, Ninomiya (JP); Kyoichi Mori, Oiso (JP); Akihiro Miyauchi, Hitachi (JP)

(21) Appl. No.: 13/193,658

(22) Filed: Jul. 29, 2011

(30) Foreign Application Priority Data
Jul. 29, 2010 (JP) 2010-169956

(51) Int. Cl. C08F 220/10

(52) U.S. Cl. 522/182

(57) ABSTRACT

A photopolymerizable resin composition for transferring a microstructure, which allows a thinner and uniform thin film to be formed, a transfer accuracy of extremely smaller microfine pattern to be excellent, and a curing time of the thin film to be shortened, is provided. The photopolymerizable resin composition for transferring a microstructure comprises the following component (A), component (B), component (C), component (D) and component (E) at the rate described below:
(A) a 6 to 15-functional acrylate; in 0.5 to 10 mass %
(B) an acrylate with a weight-average molecular weight (Mw) of 1000 to 10000; in 0.5 to 10 mass %
(C) an acrylate having a benzene ring; in 0.5 to 10 mass %
(D) a reactive diluent; in 80 to 98 mass %
(E) a photopolymerization initiator; in 0.1 to 5 mass %.

### CROSS REFERENCE TO RELATED APPLICATIONS

This application claims the foreign priority benefit under Title 35, United State Code, 119 (a)-(d) of Japanese Patent Application No. 2010-169956, filed on Jul. 29, 2010 in the Japan Patent Office, the disclosure of which is herein incorporated by reference in its entirety.

### BACKGROUND OF THE INVENTION

1. Field of the Invention

The present invention relates to a photopolymerizable resin composition for transferring a microstructure, which is used as a component material to transfer a microfine uneven pattern formed on a mold.

2. Description of Related Art

Recently, a semiconductor integrated circuit has been made extremely smaller. Formation of patterns of the extremely small circuit, which may be fabricated by photolithography, for example, has required a high degree of accuracy. However, the formation of the circuit with a high accuracy is approaching a limit, as a scale of the micro-fabrication has nearly reached a wavelength of an exposing source for use in the micro-fabrication. To obtain an even higher accuracy, an electron beam writing apparatus, which is a charged particle beam apparatus, has also been used instead of a photolithography apparatus.

However, in forming patterns of an extremely small circuit with the electron beam writing apparatus, the more patterns are drawn with the electron beam writing apparatus, the more time it takes for exposure, because the electron beam writing apparatus does not use a one-shot exposure with an exposing source such as an i-ray and an excimer laser. Hence, the more integrated the circuit becomes, the more time it takes for forming patterns, resulting in a poor throughput.

To speedup the formation of patterns using an electron beam writing apparatus, an electron beam cell projection lithography technique has been developed, in which electron beams are irradiated en bloc on a plurality of combined masks in various shapes. Such an electron beam writing apparatus for use in the electron beam cell projection lithography technique is necessarily large-sized and high-priced, because a structure of the apparatus becomes more complicated, and a mechanism for controlling each position of the masks with a higher accuracy is required.

In forming patterns of extremely small circuits, imprint lithography has also been known, in which a stamper having a microfine uneven pattern complementary to a desired one is stamped onto a surface of a material to be transferred. The material to be transferred may be, for example, a substrate having a resin layer thereon (To simplify descriptions, even after a pattern is transferred on a material to be transferred, the material to be transferred is still referred to as the “material to be transferred” hereinafter). The imprint lithography can transfer a microstructure on a 25 nm scale or less onto a resin layer of a material to be transferred. More specifically, the resin layer (which may also be referred to as a “pattern forming layer”) includes a thin film layer formed on a substrate and a patterned layer composed of protrusions formed on the thin film layer. The imprint lithography has also been applied to creation of a pattern of recording bits for a large capacity recording medium, and of a pattern of a semiconductor integrated circuit. For example, a mask for fabricating a large capacity recording medium substrate or a semiconductor integrated circuit substrate can be prepared by forming protrusions of a pattern forming layer using the imprint lithography. Then, portions of its thin film layer exposed as recesses in the pattern forming layer, and portions of its substrate that are immediately under the portions of the thin film layer, are etched to obtain a desired substrate.

Processing accuracy of etching a substrate is influenced by a distribution of thicknesses of a thin film layer in a pass-through direction thereof. To be more specific, a description is made taking as an example, a material to be transferred having a thin film layer with a difference of 50 nm between maximum and minimum thicknesses. If the material to be transferred is etched 50 nm in depth, a substrate under the thin film layer may be partly etched in a portion having a smaller thickness, while may not etched in a portion having a larger thickness. Therefore, to achieve a high processing accuracy of etching, a thickness of a thin film layer formed on a substrate has to be uniform.

Conventionally, a photopolymerizable resin composition including a (meth)acrylate is known as a resin composition for transferring a microstructure used in the imprint technique (for example, (see Japanese Laid-Open Patent Application, Publication Nos. 2007-84625 and 2007-1250). The photopolymerizable resin composition is a relatively low viscous material and applied on a substrate by a dispense method, a spin-coating method and an ink-jet method or the like.

In the meantime, a size of a microfine pattern required for a large capacity recording medium or a semiconductor integrated circuit is more and more decreasing, whereby the size is assumed to be extremely small to a several tens nm scale in the near future. That is, in order to form a microfine pattern with a several tens nm scale by the imprint technique, a photopolymerizable resin composition for transferring a microstructure has to be applied on a substrate uniformly with a thickness of a several tens nm scale.

However, a conventional photopolymerizable resin composition (see Japanese Laid-Open Patent Application, Publication Nos. 2007-84625 and 2007-1250) has a disadvantage that such a composition can not form a resin layer uniformly with the aforementioned thickness (or several tens nm scale) on a substrate. Further, when a conventional photopolymerizable resin composition (see Japanese Laid-Open Patent Application, Publication Nos. 2007-84625 and 2007-1250) is used, the transfer accuracy (or molding accuracy) is insufficiently poor. Moreover, it needs relatively longer time for photo-curing the composition after transferring a microfine pattern.

Accordingly, a demand of a photopolymerizable resin composition for transferring a microstructure is increasing, which can form a thinner and uniform thin film, more excellent in the transfer accuracy of transferring an extremely smaller microfine pattern, need a shorter photo-curing time of the formed thin film, and manufacture a microfine structure with a more improved throughput performance than a conventional photopolymerizable resin composition.

### SUMMARY OF THE INVENTION

In view of the above mentioned disadvantages, the present invention has been made in attempt to provide a photopolymerizable resin composition for transferring a microstructure, which can form a thinner and uniform thin film, more excellent in the transfer accuracy of transferring an extremely smaller microfine pattern, need a shorter photo-curing time of the formed thin film, and manufacture a microfine structure with a more improved throughput performance than a conventional photopolymerizable resin composition.

According to a first aspect of the present invention, a photopolymerizable resin composition for transferring a microstructute comprises the following components (A), (B), (C), (D) and (E) at the rate described below.

(A) a 6 to 15-functional acrylate; in 0.5 to 10 mass %

(B) an acrylate with a weight-average molecular weight (Mw) of 1000 to 10000; in 0.5 to 10 mass %

(C) an acrylate having a benzene ring; in 0.5 to 10 mass %

(D) a reactive diluent; in 80 to 98 mass %

(E) a photopolymerization initiator; in 0.1 to 5 mass %

According to a second aspect of the present invention, a photopolymerizable resin composition for transferring a microstructure comprises the following components (A), (B), (C), (D), (E) and (F) at the rate described below.

(A) a 6 to 15-functional acrylate; in 0.5 to 10 mass %

(B) an acrylate with a weight-average molecular weight (Mw) of 1000 to 10000; in 0.5 to 10 mass %

(C) an acrylate having a benzene ring; in 0.5 to 10 mass %

(D) a reactive diluent; in 80 to 98 mass %

(E) a photopolymerization initiator; in 0.1 to 5 mass %

(F) a 2-functional acrylate having viscosity of 12 mPa·s or less at 25° C.; in 0.5 to 10 mass %.

According to the present invention, it is possible to provide a photopolymerizable resin composition for transferring a microstructure, which can form a thinner and uniform thin film, more excellent in the transfer accuracy of transferring an extremely smaller microfine pattern, need a shorter photo-curing time of the formed thin film, and manufacture a microfine structure with a more improved throughput performance than a conventional photopolymerizable resin composition.

### BRIEF DESCRIPTION OF THE DRAWINGS

FIGS. 1A to 1F are schematic views for explaining steps of the method for manufacturing a microfine structure using a photopolymerizable resin composition of the present embodiment.

FIG. 2 is a SEM image of the uneven pattern (or microfine pattern) formed on the surface of the thin film made of the photopolymerizable resin composition of Example 1.

### DETAILED DESCRIPTION OF THE PREFERRED EMBODIMENT

Next, an embodiment of the present invention will be explained in detail. First, a method for manufacturing a microfine structure using a photopolymerizable resin composition of the present embodiment will be explained, and then photopolymerizable resin composition will be explained in detail.

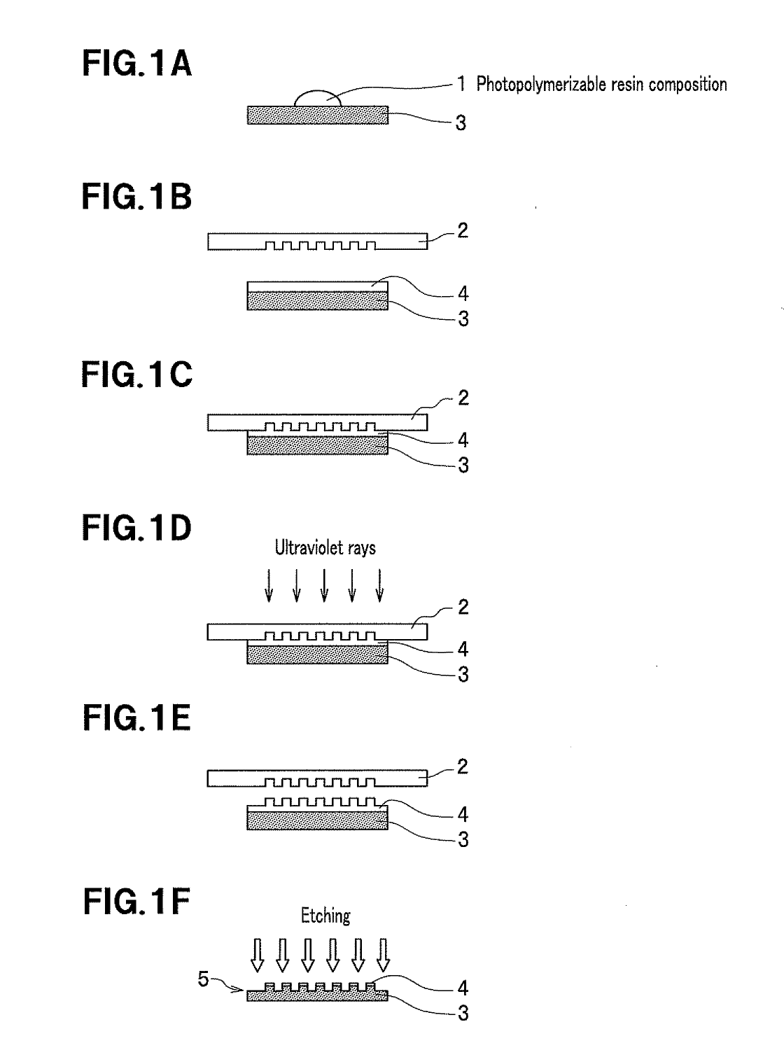

Here, FIGS. 1A to 1F next referred to, are schematic views for explaining steps of the method for manufacturing a microfine structure using a photopolymerizable resin composition of the present embodiment.

(Method of Manufacturing Microfine Structure)

The manufacturing method includes a process for manufacturing a microfine structure 5 (see FIG. 1F) on which an uneven pattern corresponding to an uneven pattern of a mold 2 (see FIG. 1B) is formed, on a substrate 3 (see FIG. 1A).

As shown in FIG. 1A, in the manufacturing method, first, a photopolymerizable resin composition 1 of the present invention, which is described hereinafter, is placed on a surface of a substrate 3. The method for placing the composition 1 is not specifically limited. For example, the composition 1 may be placed on the surface of the substrate 3 by a micropipette. A material of the substrate 3 includes, for example, silicon, various metallic materials, glass, quartz, ceramic and resin or the like. Further, the substrate 3 may have a multilayer structure on which a metallic layer, a resin layer and an oxide film layer or the like is formed. Moreover, the substrate 3 may be a material in which a center hole is fabricated.

Next, as shown in FIG. 1B, the photopolymerizable resin composition 1 is spread on the surface of the substrate 3, thereby to form a thin film 4 made of the photopolymerizable resin composition 1. As a method for spreading the photopolymerizable resin composition 1, well-known application methods may be used. Of the application methods, a spin-coating method is most preferably used, by which the photopolymerizable resin composition 1 is spread by centrifugal force by spinning the substrate 3, allowing the thin film 4 to be formed having a uniform thickness.

Note the reference No. 2 shows a mold 2 in FIG. 1B.

The mold 2 has an uneven pattern with a nanometer (nm) size on the surface thereof. In the present embodiment, the uneven pattern is a microfime pattern with a several tens nanometer size.

A method for forming the uneven pattern includes, for example, photolithography, focused ion beam lithography, electron beam writing, and nano printing, one of which may be selected according to a processing accuracy required for the uneven pattern to be created.

A material of the mold 2 is not specifically limited as long as the material has a predetermined strength and is fabricated so that the uneven pattern (or microfime pattern) having a required accuracy can be created. For example, the material of the mold 2 includes a silicon wafer, various metallic materials, glass, quartz, ceramic and resin materials. Of the above mentioned materials, quartz, Si, SiC, SiN, polycrystal silicon, Ni, Cr, Cu, a cured material made of a photocurable resin material, and the combination of at least two above mentioned materials are preferable materials of the mold 2.

Further, as a material of the mold 2, as described hereinafter, when ultraviolet rays are irradiated to the thin film 4 through the mold 2 (see FIG. 1D), the mold 2 is required to have an optical transparency. In this regard, particularly, quartz having a high optical transparency is a preferable material of the mold 2. In contrast, when ultraviolet rays (not shown) are irradiated to the thin film 4 from the side of the substrate 3 which has an optical transparency in FIG. 1D, the mold 2 may be formed using an opaque material.

Further, as shown in FIG. 1C, when a mold 2 made of a resin material is capable of being elastically deformed, even if a foreign substance (not shown) exists on the surface of the substrate 3 when the mold 2 is pressed to the thin film 4, the mold 2 may be elastically deformed corresponding to the shape of the foreign substance. Therefore, such a material with the elastic deformation property is preferable, because the material allows the non-contacting area of the mold 2 caused near the foreign substance to be reduced to the minimum.

Next, as shown in FIG. 1C, the thin film 4 is pressed by the mold 2, whereby an uneven pattern corresponding to the uneven pattern of the mold 2 is transferred on the thin film 4.

Next, as shown in FIG. 1D, in the manufacturing method, ultraviolet rays (wavelength 365 nm) are irradiated to the thin film 4 from the rear side of the mold 2 (or the side where the uneven pattern is formed in the thin film 4), thereby to cure the thin film 4.

Then, as shown in FIG. 1E, the mold 2 is peeled from the thin film 4, thereby to obtain the thin film 4 on which the uneven pattern of the mold 2 is transferred. Then, the substrate 3 is etched by using the thin film 4 as a resist film.

Accordingly, as shown in FIG. 1B, in the manufacturing method, the substrate 3 is etched by using the protrusion parts of the thin film 4 in FIG. 1E as the mask, whereby a microfine structure 5 may be obtained comprising the substrate 3 (see FIG. 1A) having the uneven pattern corresponding to the uneven pattern (or microfine pattern) of the mold 2 (see FIG. 1B)

(Photopolymerizable Resin Composition)

The photopolymerizable resin composition 1 (hereinafter, the reference No. will be omitted) of the present embodiment comprises: a component (A) of a 6 to 15-functional acrylate, a component (B) of an acrylate with a weight-average molecular weight (Mw) of 1000 to 10000, a component (C) of an acrylate having a benzene ring, a component (D) of a reactive diluent, and a component (E) of a photopolymerization initiator, at the predetermined rate.

<Component A>

Here, the 6 to 15-functional acrylate may include an acrylate monomer or oligomer having 6 to 15 acryl functional groups, for example, dipentaerythritol hexaacrylate. Further, a 6 to 15-functional urethane acrylate or a polyester acrylate may be used. As a poly functional urethane acrylate, a compound may be used, which is obtained by the urethane reaction of the acrylate monomer having an acryloyl group and a hydroxyl group, with polyisocyanate.

Further, as the poly functional urethane acrylate, a commercially available product may be used, for example, including: UV-1700B (Nippon Synthetic Chemical Industry Co, Ltd.; urethane acrylate oligomer having a 6-functional or more acrylate), UA-53H (Shin-Nakamura Chemical Co., Ltd.; urethane acrylate oligomer having a 15-functional acrylate), EBECRYL (registered trademark) 220 (Daicell-Cytec Co., Ltd.; urethane acrylate oligomer having a 6-functional acrylate), and UN-3320HA (Negami Chemical Industrial Co., Ltd.; urethane acrylate oligomer having a 6-functional acrylate).

Further, as the poly functional polyester acrylate, a commercially available product may be used, for example, including: EBECRYL1830 (Daicell-Cytec Co., Ltd.; polyester acrylate oligomer having a 6-functional acrylate), and EBECRY450 (Daicell-Cytec Co., Ltd.; polyester acrylate oligomer having a 6-functional acrylate).

The content of the component (A) in the photopolymerizable resin composition is 0.5 to 10 mass %. The photopolymerizable resin composition containing the component (A) in the aforementioned range of the content is excellent in the transfer accuracy (or molding accuracy) of the uneven pattern (or microfine pattern) when the mold 2 is pressed to the thin film 4 (see FIG. 1C).

<Component (B)>

The acrylate having a weight-average molecular weight (Mw) of 1000 to 10000 includes, for example, methyl poly(meth)acrylate, an ethoxylated bisphenol A type acrylate, an aromatic urethane acrylate, an aliphatic urethane acrylate, and a polyester acrylate or the like. As a commercially available product, such a product includes: EBECRYL 8405 (Daicell-Cytec Co., Ltd.; urethane acrylate oligomer having a 4-functional acrylate, weight-average molecular weight (Mw) of 2700), and UV-7000B (Nippon Synthetic Chemical Industry Co., Ltd.; urethane acrylate oligomer having a 2-functional acrylate, a weight-average molecular weight (Mw) of 5000). The acrylate of the component (B) may be used in the combination of 2 or more members of the aforementioned acrylates.

Further, as the component (B), the aforementioned component (A) with the weight-average molecular weight from 1000 to 10000 may be also used.

The content of the component (B) in the photopolymerizable resin composition is 0.5 to 10 mass %. The photopolymerizable resin composition containing the component (B) in the aforementioned range of the content is excellent in a film-forming property when the thin film 4 (see FIG. 1B) is formed on the substrate 3.

<Component (C)>

As the acrylate having a benzene ring, an acrylate monomer having an acryloyl group and a benzene ring may be used. The examples include a phenoxy glycol acrylate, phenoxyethylene glycol acrylate, phenoxypolyethylene glycol acrylate, ethoxylated bisphenol A diacrylate, propoxylated bisphenol A diacrylate, and benzyl acrylate or the like.

The content of the component (C) in the photopolymerizable resin composition is 0.5 to 10 mass %. The photopolymerizable resin composition containing the component (C) with the aforementioned range of the content is excellent in etching resistance property when the substrate 3 is etched using the cured thin film 4 as a resist film, as shown in FIG. 1F.

<Component (D)>

Here, a reactive diluent is an agent which reduces viscosity of the photopolymerizable resin composition by mainly diluting the aforementioned components (A) to (C). The reactive diluent is not specifically limited as long as the reactive diluent has a functional group capable of performing a cross-linking reaction with the components (A) to (C), respectively. However, preferably, the reactive diluent is a monomer, especially including a monomer having at least one member selected from a (meth)acrylate group, a vinyl group, an epoxy group and an oxetanyl group, at the end of the monomer.

The reactive diluent includes, for example, N-vinylpirrolidone, acryloyl morpholine, N,N-dimethyl acrylamide, N-methyrol acrylamide, N,N-dimethylaminopropyl acrylamide, vinyl(meth)acrylate, allyl(meth)acrylate, methallyl(meth)acrylate, acryl glycidyl ether, alkylphenol monoglycidyl ether, allyl glycidyl ether, 2-ethylhexyl glycidyl ether, phenyl glycidyl ether and 2-ethylhexyloxetane or the like. These reactive diluents may be used in the combination of 2 or more members selected from the aforementioned reactive diluents.

Of the above mentioned reactive diluents, a (meth)acrylate with the viscosity of 3 mPa·s or less at 25° C. is preferably used.

Further, of the above mentioned reactive diluents, a mono functional (meth)acrylate is preferably used.

Further, the reactive diluent preferably has a volatile property at 25° C. including, for example, a (meth)acrylate having a straight chain alkylene group with 1 to 6 carbon atoms, and a (meth)acrylate having an alkylene group which does not have a substituted group except for a hydrogen atom (for example, an alkyl group and a hydroxyl group (note an alkoxy group branched to form an ether bond is omitted)) at the branched position.

Such a preferable reactive diluent includes: methyl(meth) acrylate, ethyl(meth)acrylate, butyl(meth)acrylate, hexyl (meth)acrylate, 2-methoxyethyl(meth)acrylate, 2-ethoxyethyl (meth)acrylate, 3-methoxybutyl(meth)acrylate, allyl(meth) acrylate, and cyano(meth)acrylate.

The content of the component (D) in the photopolymerizable resin composition is 80 to 98 mass %. The photopolymerizable resin composition containing the component (D) in the aforementioned range of the content may form a thin film 4 with a thickness of several tens nm when the thin film 4 is formed on the substrate 3, as shown in FIG. 1B. Particularly, when the aforementioned volatile reactive diluent is used, the uniform thin film 4 may be formed without particularly performing a baking treatment when the thin film 4 is formed on the substrate 3.

<Component (E)>

As a photopolymerization initiator, a radical polymerization initiator is used. For example, the photopolymerization initiator includes: 1-hydroxycyclohexyl phenyl ketone, 2-hydroxy-2-methyl-1-phenylpropan-1-one, 1-[4-(2-hydroxyethoxy)phenyl]-2-hydroxy-2-methyl-1-propane-1-one, 2-hydroxy-1-{4-[4-(2-hydroxy-2-methylpropionyl)-benzyl]phenyl}-2-methylpropane-1-one, 2-methyl-1-(4-methylthiophenyl)-2-morpholinopropane-1-one, 2-benzyl-2-dimethylamino-1-(4-morpholinophenyl-butanone-1,2-(dimethylamino)-2-[(4-methylphenyl)methyl]-1-[4-(4-morphonyl)phenyl]-1-butanone, 2-(dimethylamino)-2-[(4-methylphenyl)methyl]-1-[4-(4-morpholinyl)phenyl]-1-butanone, 2,4,6-trimethylbenzoyl-diphenyl-phosphinoxide and bis-(2,4,6-trimethylbenzoyl)-phenylphosphinoxide or the like. These photopolymerization initiators may be used in the combination of or more members selected from the above mentioned photopolymerization initiators.

The content of the component (E) in the photopolymerizable resin composition is 0.1 to 5 mass %. The photopolymerizable resin composition containing the component (E) in the aforementioned range of the content may be rapidly cured when ultraviolet rays are irradiated to the thin film 4 (or photopolymerizable resin composition) as shown in FIG. 1D.

According to the photopolymerizable resin composition of the present embodiment described above, the photopolymerizable resin composition includes the components (A) to (E) at the predetermined rate, respectively. Accordingly, it is possible to provide a photopolymerizable resin composition for transferring a microstructure, which can form a thinner and uniform thin film, more excellent in the transfer accuracy of transferring an extremely smaller microfine pattern, need a shorter photo-curing time of the formed thin film, and manufacture a microfine structure with a more improved throughput performance than a conventional photopolymerizable resin composition (for example, see Japanese Laid-Open Patent Application, Publication Nos. 2007-84625 and 2007-1250).

Further, the photopolymerizable resin composition of the present embodiment may further include a component (F), which will be described below, in addition to the components (A) to (E).

<Component (F)>

The component (F) is a 2-functional acrylate having viscosity of 12 mPa·s or less at 25° C. The examples include: polyethylene glycol diacrylate, polypropyrene glycol diacrylate, 1,4-butandiol diacrylate, 1,6-hexanediol diacrylate, 1,9-nonanediol diacrylate, and neopentyl glycol diacrylate or the like.

The content of the component (A) in the photopolymerizable resin composition is 0.1 to 5 mass %, the content of the component (B) therein is 0.5 to 10 mass %, the content of the component (C) therein is 0.5 to 10 mass %, the content of the component (D) therein is 80 to 98 mass %, the content of the component (E) therein is 0.1 to 5 mass %, and the content of the component (F) therein is 0.5 to 10 mass %.

According to the photopolymerizable resin composition as described above, the photopolymerizable resin composition including the components (A) to (E) is more excellent in the film-forming property, the rapid curing property, and the pattern-forming property than the conventional photopolymerizable resin composition. Moreover, by further including the component (F), it is possible to further improve the pattern-forming property without deteriorating the film-forming property and the rapid curing property of the photopolymerizable resin composition.

Further, the photopolymerizable resin composition including the components (A) to (E), and the photopolymerizable resin composition further including the component (F) allow a thinner and uniform thin film to be formed by containing a reactive diluent made of the (meth)acrylate having viscosity of 3 mPa·s or less at 25° C.

Further, the above mentioned photopolymerizable resin composition may include a reactive diluent made of a mono functional (meth)acrylate. This allows the thin film to be cured in a shorter time than a reactive diluent made of a polyfunctional (meth)acrylate when ultraviolet rays are irradiated to the thin film.

Further, the above mentioned photopolymerizable resin composition may include a volatile (meth)acrylate, more specifically, a (meth)acrylate having a straight chain alkylene group with 1 to 6 carbon atoms. This allows a uniform thin film to be formed on the substrate without performing a baking treatment.

The microfine structure manufactured by using the above mentioned photopolymerizable resin composition may be applied to an information recording medium such as a magnetic recording medium and an optical recording medium. Further, the microfine structure may also be applied to a large-scale integrated circuit component; an optical component such as a lens, a polarizing plate, a wavelength filter, a light emitting device, and an integrated optical circuit; and a biodevice for use in an immune assay, a DNA separation, and a cell culture.

Hereinbefore, the embodiment of the present invention has been explained in detail. However, the present invention is not limited to the above mentioned embodiment, and various modifications may be performed.

For example, the microfine structure of the aforementioned embodiment is configured by a substrate which is etched using the cured thin film 4 made of the photopolymerizable resin composition of the present embodiment as a resist film. However, as shown in FIG. 1E, a product comprising the substrate 3 on which the cured thin film 4 having the transferred uneven pattern (or microfine pattern) is formed may also be used as a microfine structure without conducting the next etching treatment (see FIG. 1F).

Further, the photopolymerizable resin composition of the aforementioned embodiment may contain other components such as a surfactant and a polymerization inhibitor, where necessary.

### EXAMPLES

Next, the photopolymerizable resin composition of the present invention will be described more specifically in reference to examples. Note that in the explanation hereinafter, a content [mass %] of each component in the photopolymerizable resin composition will be simply described as [%] for short.

### Example 1

In Example 1, the components (A) to (E) were mixed so that a photopolymerizable resin composition contained each component [%] as shown in Table 1. Then, the mixture was filtrated through a filter made of polypropyrene with a sieve mesh size of 100 nm diameter, whereby a desired photopolymerizable resin composition was obtained.

TABL1E 1

| | | Examples | | | | | Comparative Examples | | | | |
|---|---|---|---|---|---|---|---|---|---|---|---|
| | | 1 | 2 | 3 | 4 | 5 | 1 | 2 | 3 | 4 | 5 |
| Contents of | Component (A) | 1 | 1 | 1 | 2 | 1 | 1 | — | — | 1 | 1 |
| Photopolymerizable | Component (B) | 1 | 1 | 1 | 2 | 1 | 1 | 1 | 1 | — | 1 |
| Resin Composition | Component (C) | 2 | 2 | 2 | 4 | 1 | 95.5 | 2 | 2 | 2 | — |
| [mass %] | Component (D) | 95.5 | 95.5 | 95.5 | 90 | 95.5 | 2 | 95.5 | 86 | 95.5 | 95.5 |
| | Component (E) | 0.5 | 0.5 | 0.5 | 2 | 0.5 | 0.5 | 0.5 | 1 | 0.5 | 0.5 |
| | Component (F) | — | — | — | — | 1 | 0.5 | 0.5 | 1 | 0.5 | 0.5 |
| | Component (A)′ | — | — | — | — | — | — | 1 | 10 | — | — |
| | Component (B)′ | — | — | — | — | — | — | — | — | 1 | — |
| | Component (C)′ | — | — | — | — | — | — | — | — | — | 2 |
| Evaluation Results | Film-Forming Property | Good | Good | Good | Good | Good | Poor | Good | Poor | Poor | Good |
| | Curing Property | Good | Good | Good | Good | Good | — | Good | — | — | Poor |
| | Transfer Accuracy | Good | Good | Good | Good | Good | — | Poor | — | — | — |

Here, as “a 6 to 15-functional acrylate” of the component (A), the 6-functional acrylate (Shin-Nakamura Chemical Co., Ltd.; dipentaerythritol hexaacrylate) was used.

As “an acrylate with a weight-average molecular weight (Mw) of 1000 to 10000” of the component (B), the acrylate with a weight-average molecular weight (Mw) of 5000 (UV-7000B, Nippon Synthetic Chemical Industry Co., Ltd., a 2 to 3-functional urethane acrylate) was used.

As “an acrylate having a benzene ring” of the component (C), the acrylate having a benzyl group (Hitachi Chemical Co., Ltd., benzyl acrylate) was used.

As “a reactive diluent” of the component (D), a volatile reactive diluent (Tokyo Chemical Industry Co., Ltd., butyl acrylate) was used.

As “a photopolymerization initiator” of the component (E) the radical polymerization initiator (CIBA Japan Ltd., IRGACURE (registered trademark) 369) was used.

Next, by using the photopolymerizable resin composition prepared in the present example, a microfine structure 5 (see FIG. 1F) was produced through the steps shown in FIGS. 1A to 1F.

As a substrate 3 shown in FIG. 1A, a silicon (Si) wafer having a thickness of 0.625 mm and a diameter of 65 mm was used.

In the present example, as shown in FIG. 1A, the photopolymerizable resin composition 1 (500 μL) was dropped on the substrate 3 by using a micropipette.

Next, the photopolymerizable resin composition 1 dropped on the substrate 3 was spread by a spin-coating method, thereby to form a thin film 4 shown in FIG. 1B. The spin-coating method was conducted under the conditions of a rotating speed of 5000 rpm and a rotating time of 60 sec. Then, the thicknesses of the thin film 4 were measured by an ellipsometer at the 12 points on the surface of the formed thin film 4. Accordingly, it was confirmed that the thin film 4 was formed as a uniform film having a thickness in the range of 45±2 nm.

Next, as shown in FIG. 1C, a mold 2 was pressed on the thin film 4, thereby to transfer the uneven pattern (or microfine pattern) of the mold 2 on the thin film 4. As the mold 2, a circular shaped mold made of quartz having a thickness of 0.7 mm and a diameter of 150 mm was used. The uneven pattern (or microfine pattern) of the mold 2 was a pattern repeatedly forming concentric circular lines and spaces (having a line width of 50 nm, a pitch of 90 nm and a height of 40 nm) at the ring shaped area formed between circles with inner diameters of 30 mm and 60 mm of the mold 2. Note the mold 2 was pressed on the thin film 4 at 0.2 Mpa.

Next, as shown in FIG. 1D, ultraviolet rays (wavelength of 365 nm) were irradiated through the mold 2 to the thin film 4 by using a predetermined ultraviolet ray lamp (not shown in FIG. 1D), whereby the thin film 4 made of the photopolymerizable resin composition 1 (see FIG. 1A) was cured.

Herein, it was confirmed that when a ultraviolet ray lamp having a ultraviolet irradiation quantity of 100 mJ/cm² (or a predetermined output) was used, the thin film 4 was cured in a smaller irradiation quantity (or shorter irradiation time) than a usual condition.

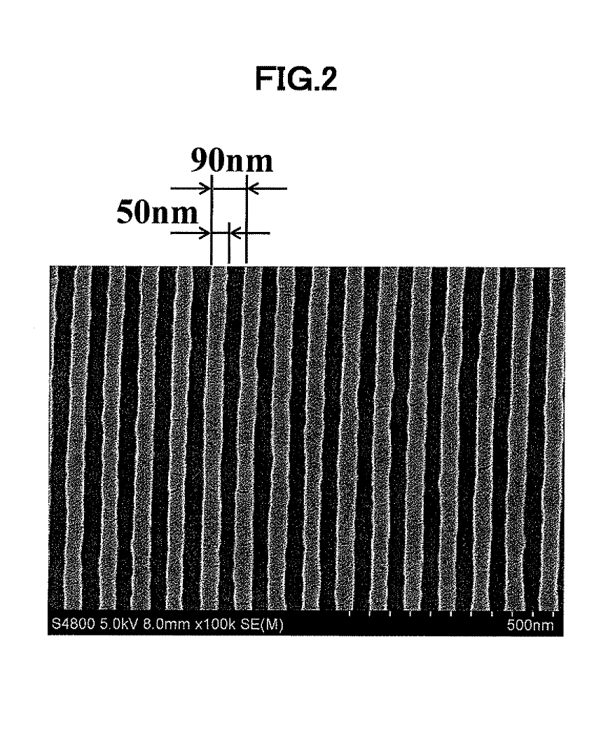

Then, as shown in FIG. 1E, the mold 2 is peeled from the cured thin film 4, thereby to obtain the thin film 4 on which the uneven pattern (or microfine pattern) of the mold 2 was transferred. Then, the surface of the thin film 4 was observed by SEM. Accordingly, it was confirmed that the concentric circular uneven pattern (or microfine pattern) comprising lines and spaces with a line width of 50 nm and a pitch of 90 nm was formed on the surface of the thin film 4. FIG. 2 shows a SEM image of the uneven pattern (or microfine pattern) formed on the surface of the thin film 4 made of the photopolymerizable resin composition in Example 1.

Next, as shown in FIG. 1F, the substrate 3 was etched by using the thin film 4 as a resist film, on which the uneven pattern (or microfine pattern) was transferred, whereby the microfine structure 5 was obtained. Herein, in the above mentioned process, the oxygen plasma etching was performed until the surface of the substrate 3 was exposed, and subsequently the fluorine-based gas etching was performed instead of the oxygen plasma etching, thereby to obtain the microfine structure 5. Then, the surface of the microfine structure 5 was observed by SEM. As shown in FIG. 2, the concentric circular uneven pattern (or microfine pattern) comprising lines and spaces with a line width of 50 nm and a pitch of 90 nm was formed on the surface of the microfine structure 5. In other words, it was confirmed that the thin film 4 formed by curing the photopolymerizable resin composition 1 (see FIG. 1A) showed the sufficient etching resistance.

Then, the photopolymerizable resin composition 1 obtained in the present example (see FIG. 1A) was evaluated on the film-forming property, the curing property and the transfer accuracy.

<Film-Forming Property>

In the step shown in FIG. 1B, the thicknesses of the thin film 4 were measured at the 12 points on the surface of the thin film 4 formed on the substrate 3. When the thin film 4 having a uniform thickness of 50 nm or less was formed, the film-forming property was evaluated as “good”, while the thin film 4 having the aforementioned uniform thickness was not formed was evaluated as “poor”. Table 1 shows the result.

<Curing Property>

In the step shown in FIG. 1D, when ultraviolet rays (wavelength of 365 nm) were irradiated through the mold 2 to the thin film 4 and the thin film 4 was cured within the irradiation quantity of 200 mJ/cm², the curing property thereof was evaluated as “good”, deciding that the thin film 4 was capable of being cured by the smaller irradiation quantity (or shorter irradiation time) than a usual condition. In contrast, the thin film 4 was not cured within the irradiation quantity of 200 mJ/cm², the curing property thereof was evaluated as “poor”, deciding that the thin film 4 was cured in the similar or inferior condition to the usual condition. Table 1 shows the result.

<Transfer Accuracy>

In the step shown in FIG. 1E, when the concentric circular uneven pattern (having a line width of 50 nm, a pitch of 90 nm and a height of 40 nm) was transferred on the thin film 4, the transfer accuracy was evaluated as “good”, while when the above mentioned uneven pattern was not transferred, the transfer accuracy was evaluated as “poor”. Table 1 shows the result.

### Example 2

In Example 2, a photopolymerizable resin composition was prepared in the same method as in Example 1 except that a 15-functional acrylate (Shin-Nakamura Chemical Co., Ltd.; urethane oligomer acrylate, UA-53H) was used as the component (A) instead of the 6-functional acrylate. By using the photopolymerizable resin composition, a microfine structure 5 (see FIG. 1F) was obtained. Herein, it was confirmed that the thin film 4 (see FIG. 1E) formed by curing the photopolymerizable resin composition showed the sufficient etching resistance.

Then, the photopolymerizable resin composition obtained in the present example was evaluated on the film-forming property, the curing property and the transfer accuracy in the same method as in Example 1. Table 1 shows the result.

### Example 3

In Example 3, a photopolymerizable resin composition was prepared in the same method as in Example 1 except that the acrylate with the weight-average molecular weight (Me) of 5000 (Nippon Synthetic Chemical Industry Co., Ltd.; urethane acrylate oligomer, UV-7000B) was used as the component (B) instead of the acrylate with the weight-average molecular weight (Me) of 2700. By using the photopolymerizable resin composition, a microfine structure 5 (see FIG. 1F) was obtained. Herein, it was confirmed that the thin film 4 (see FIG. 1E) formed by curing the photopolymerizable resin composition showed the sufficient etching resistance.

Then, the photopolymerizable resin composition obtained in the present example was evaluated on the film-forming property, the curing property and the transfer accuracy in the same method as in Example 1. Table 1 shows the result.

### Example 4

In Example 4, a photopolymerizable resin composition was prepared in the same method as in Example 1 except that volatile 2-methoxyethyl acrylate (Tokyo Chemical Industry Co., Ltd.) was used as the component (D) instead of butyl acrylate and the contents [%] of the components (A) to (E) were changed as shown in Table 1. By using the photopolymerizable resin composition, a microfine structure 5 (see FIG. 1F) was obtained. Herein, it was confirmed that the thin film 4 (see FIG. 1E) formed by curing the photopolymerizable resin composition showed the sufficient etching resistance.

Then, the photopolymerizable resin composition obtained in the present example was evaluated on the film forming property, the curing property and the transfer accuracy in the same method as in Example 1. Table 1 shows the result.

### Example 5

In Example 5, the components (A) to (F) were mixed to give the composition containing the respective contents [%] of the components (A) to (F) shown in Table 1. Then, the mixture was filtrated through a filter made of polypropyrene with a sieve mesh size of a 100 nm diameter, whereby a desired photopolymerizable resin composition was obtained.

Herein, as “a 6 to 15-functional acrylate” of the component (A), the 6-functional acrylate (Shin-Nakamura Chemical Co., Ltd.; dipentaerythritol ethoxylated hexaacrylate) was used.

As “an acrylate with the weight-average molecular weight (Mw) of 1000 to 10000 of the component (B), the acrylate with the weight-average molecular weight (Mw) of 5000 (Nippon Synthetic Chemical Industry Co, Ltd.; UV-3000B, 2-functional urethane acrylate) was used.

As “an acrylate having a benzene ring” of the component (C), the acrylate having a benzyl group (Hitachi Chemical Co., Ltd., benzyl acrylate) was used.

As “a reactive diluent” of the component (D), the volatile reactive diluent (Tokyo Chemical Industry Co., Ltd., butyl acrylate) was used.

As “a photopolymerization initiator” of the component (E) the radical polymerization initiator (CIBA Japan Ltd., IRGACURE (registered trademark) 369) was used.

As “a 2-functional acrylate having viscosity of 12 mPa·s or less at 25° C.” of the component (F), 1,4-butanediol diacrylate (Tokyo Chemical Industry Co., Ltd.) was used.

Then, the photopolymerizable resin composition obtained in the present example was evaluated on the film-forming property, the curing property and the transfer accuracy in the same method as in Example 1. Table 1 shows the result.

### Comparative Example 1

In Comparative Example 1, the photopolymerizable resin composition was prepared as in Example 1 except that the combination of the components (C) and (D) was changed to the composition shown in Table 1. Then, by using the photopolymerizable resin composition, the thin film 4 shown in FIG. 1B was tried to be formed by the spin-coating method in the same method as in Example 1, whereby the thickness of the thin film 4 was 500 nm or more.

Accordingly, the evaluation of the film-forming property when the photopolymerizable resin composition in Comparative Example 1 was used, resulted in “poor” as shown in Table 1.

Note that the curing property and the transfer accuracy of the composition were not evaluated because the film-forming property of the photopolymerizable resin composition in Comparative Example 1 was evaluated as “poor”.

### Comparative Example 2

In Comparative Example 2, the photopolymerizable resin composition was prepared as in Example 1 except that the 2-functional acrylate (Tokyo Chemical Industry Co., Ltd.; 1,4-butanediol diacrylate) shown in Table 1 as the component (A)′ was used instead of the 6-functional acrylate as the component (A). Then, the thin film 4 on which the uneven pattern (or microfine pattern) was transferred was obtained as shown in FIG. 1E.

Hereby, the film-forming property and the curing property of the photopolymerizable resin composition in Comparative Example 2 were good, resulting in each evaluation as “good”.

However, when the surface of the thin film 4 on which the uneven pattern (or microfine pattern) was transferred was observed by SEM, the uneven pattern (or microfine pattern) partially deficient in lines and spaces was detected. Therefore, the evaluation of the transfer accuracy of the photopolymerizable resin composition in Comparative Example 2 resulted in “poor” as shown in Table 1.

### Comparative Example 3

In Comparative Example 3, the photopolymerizable resin composition was prepared as in Example 1 except that the 2-functional acrylate (Tokyo Chemical Industry Co., Ltd.; 1,4-butanediol diacrylate) shown in Table 1 as the component (A)′ was used in 10% instead of the 6-functional acrylate as component (A), and the respective contents [%] of the components (B) to (E) in the composition were changed as shown in Table 1. Then, by using the photopolymerizable resin composition, the thin film 4 shown in FIG. 1B was tried to be formed by the spin-coating method in the same method as in Example 1, whereby the thickness of the thin film 4 was 200 nm or more.

Accordingly, the evaluation of the film-forming property when the photopolymerizable resin composition in Comparative Example 3 was used, resulted in “poor” as shown in Table 1.

Note that the curing property and the transfer accuracy of the composition were not evaluated because the film-forming property of the photopolymerizable resin composition in Comparative Example 3 was evaluated as “poor”.

### Comparative Example 4

In Comparative Example 4, the photopolymerizable resin composition was prepared as in Example 1 except that the acrylate with the weight-average molecular weight (Mw) of 500 (Daicell-Cytec Co., Ltd.; EBECRYL 600, 2-functional bisphenol A epoxy acrylate) shown as the component (B)′ in Table 1 was used instead of the acrylate with the weight-average molecular weight (Mw) of 2700 as the component (B). Then, by using the photopolymerizable resin composition, the thin film 4 shown in FIG. 1B was tried to be formed by the spin-coating method in the same method as in Example 1. However, the thin film 4 spread on the substrate 3 was contracted by the surface tension as the time passed, and was not capable of keeping the shape as a film.

Accordingly, the evaluation of the film forming property when the photopolymerizable resin composition in Comparative Example 4 was used, resulted in “poor” as shown in Table 1.

Note that the curing property and the transfer accuracy of the composition were not evaluated because the film-forming property of the photopolymerizable resin composition in Comparative Example 4 was evaluated as “poor”.

### Comparative Example 5

In Comparative Example 5, the photopolymerizable resin composition was prepared as in Example 1 except that benzyl (meth)acrylate (Hitachi Chemical Co., Ltd.) shown in Table 1 as the component (C)′, which was not an acrylate, was used instead of the acrylate having a phenoxy group as the component (C). Then, by using the photopolymerizable resin composition, the thin film 4 was formed on the substrate 3 by the spin-coating method, as shown in FIG. 1B. Hereby, it was confirmed that the thickness of the thin film 4 was 46±3 nm, showing that the thin film 4 was a uniform film.

Accordingly, the evaluation of the film-forming property when the photopolymerizable resin composition in Comparative Example 5 was used, resulted in “good” as shown in Table 1.

However, as shown in FIG. 1D, when ultraviolet rays were irradiated to the thin film 4 in the same method as in Example 1, the thin film 4 was not cured even by increasing the irradiation quantity to 300 mJ/cm².

Accordingly, when the photopolymerizable resin composition in Comparative Example 5 was used, the evaluation of the curing property resulted in “poor” as shown in Table 1.

As shown in the evaluation results in Table 1, it was confirmed that the photopolymerizable resin composition containing the components (A) to (E) at the predetermined rate allowed the thin and uniform thin film with a thickness of 50 nm or less to be formed, the transfer accuracy of the microfine pattern having the extremely smaller size than a 100 nm size to be excellent; the curing time of the formed thin film to be shortened, and the microfine structure 5 (see FIG. 1F) with a more improved throughput performance than the conventional one to be produced.

What is claimed is:

1. A photopolymerizable resin composition for transferring a microstructure, comprising a component (A), a component (B), a component (C), a component (D) and a component (E), wherein
the component (A) is a 6 to 15-functional acrylate and contained in 0.5 to 10 mass %,
the component (B) is an acrylate of which weight-average molecular weight (Mw) is in the range of 1000 to 10000 and contained in 0.5 to 10 mass %,
the component (C) is an acrylate having a benzene ring and contained in 0.5 to 10 mass %,
the component (D) is a reactive diluent and contained in 80 to 98 mass %, and
the component (E) is a photopolymerization initiator and contained in 0.1 to 5 mass %.

2. The photopolymerizable resin composition for transferring a microstructure as described in claim 1, wherein the reactive diluent of the component (D) has viscosity of 3 mPa·s or less at 25° C.

3. The photopolymerizable resin composition for transferring a microstructure as described in claim 1, wherein the reactive diluent of the component (D) contains a mono functional (meth)acrylate.

4. The photopolymerizable resin composition for transferring a microstructure as described in claim 1, wherein the reactive diluent of the component (D) is volatile at 25° C.

5. A photopolymerizable resin composition for transferring a microstructure, comprising a component (A), a component (B), a component (C), a component (D), a component (E) and a component (F), wherein
the component (A) is a 6 to 15-functional acrylate and contained in 0.5 to 10 mass %,
the component (B) is an acrylate of which weight-average molecular weight (Mw) is in the range of 1000 to 10000 and contained in 0.5 to 10 mass %,
the component (C) is an acrylate having a benzene ring and contained in 0.5 to 10 mass %,
the component (D) is a reactive diluent and contained in 80 to 98 mass %,
the component (E) is a photopolymerization initiator and contained in 0.1 to 5 mass %, and
the component (F) is a 2-functional acrylate having viscosity of 12 mPa·s or less at 25° C. and contained in 0.5 to 10 mass %.

6. The photopolymerizable resin composition for transferring a microstructure as described in claim 5, wherein the reactive diluent of the component (D) has viscosity of 3 mPa·s or less at 25° C.

7. The photopolymerizable resin composition for transferring a microstructure as described in claim 5, wherein the reactive diluent of the component (D) contains a mono functional (meth)acrylate.

8. The photopolymerizable resin composition for transferring a microstructure as described in claim 5, wherein the reactive diluent of the component (D) is volatile at 25° C.
